(19) United States
(12) Patent Application Publication
(10) Pub. No.: US 2007/0127472 A1
(43) Pub. Date: Jun. 7, 2007

(54) Broadcast data communicating method, broadcast data receiving terminal, and broadcast data transmitting server

(75) Inventors: Yoshifumi Yonemoto, Kanagawa (JP); Daiji Ido, Tokyo (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 10/588,261

(22) PCT Filed: Feb. 1, 2005
(86) PCT No.: PCT/JP05/01420

§ 371 Date: Aug. 3, 2006

(30) Foreign Application Priority Data
Feb. 5, 2004 (JP) 2004-029888

(51) Int. Cl. H04L 12/56

(52) U.S. Cl. 370/390; 370/312

(57) ABSTRACT

A broadcast data communication method is capable of reducing unnecessary power consumption accompanying the reception of broadcast data that is not desired by a user and it is possible to reduce annoyance accompanying the performing of broadcast notification by not carrying out broadcast notification for broadcast data the user does not desire. In this method, a broadcast notification information identifier is added to broadcast notification information at a broadcast data transmission server of a broadcast data communication system. The broadcast notification information is received at the broadcast data receiving terminal (S1). The broadcast notification information identifier is then saved as notification unnecessary information (S8), and reception of broadcast data corresponding to broadcast notification information containing a broadcast notification information identifier that is the same as the saved broadcast notification information identifier is stopped (S9).

### TECHNICAL FIELD

The present invention relates to a broadcast data communication method, broadcast data receiving terminal, and broadcast data transmission server, and particularly relates to a broadcast data communication method, broadcast data receiving terminal, and broadcast data transmission server adopting a broadcast/multicast communication method for transmitting multimedia data such as images, music, audio, news and display data, etc.

### BACKGROUND ART

In recent years, a large number of dedicated channels such as for movies, music and news etc. have been prepared for large capacity broadcasts such as digital satellite broadcasts, etc. Programs are broadcast at these dedicated channels according to the respective dedicated planning and content.

Further, broadcast schemes for receiving terrestrial digital broadcasts at mobile terminals or broadcast schemes for transmitting broadcast data utilizing mobile communication networks have been attempted.

Methods of receiving broadcast data after listening to broadcast notification on an information channel are well-known as methods of receiving carbon copy data (including broadcasting and multicasting) for broadcast data at a mobile terminal are well known (for example, see Patent Document 1).

Patent Document 1: Japanese Patent Publication No. 3022530.

### DISCLOSURE OF INVENTION

Problems to be Solved by the Invention

However, with the mobile terminal described above, broadcast data is received unconditionally every time broadcast notification is received. Because of this, at the mobile terminal, there is a problem that unnecessary power consumption occurs with regards to broadcast programs that have already been viewed or broadcast programs that it is not necessary to view in that broadcast data is received even when the user is not viewing.

It is therefore an object of the present invention to provide a broadcast data communication method, broadcast data receiving terminal and broadcast data transmission server capable of reducing unnecessary power consumption accompanying the reception of broadcast data that is not desired by a user, and capable of reducing annoyance accompanying the performance of information broadcasting by not carrying out broadcasting of information relating to broadcast data that is not desired by the user.

Means for Solving the Problem

A broadcast data communication method of the present invention adopts a configuration comprising a transmission step of transmitting broadcast notification information containing a broadcast notification information identifier by a server, a receiving step of receiving the broadcast notification information by a terminal, a transmission step of transmitting receivable notification information for the broadcast data from the terminal to the server based on the broadcast communication information, a transmission step of transmitting broadcast data based on the receivable notification information by the server, a receiving step of receiving the broadcast data by the terminal, and an ending step of saving the broadcast notification information identifier of the broadcast notification information, and ending reception of broadcast notification information containing a broadcast notification information identifier that is the same as the saved broadcast notification information identifier by the terminal.

The broadcast data receiving terminal of the present invention also adopts a configuration including a communication section that receives broadcast communication information containing a broadcast notification information identifier and broadcast data, and transmits receivable notification information for the broadcast data, a saving section that saves a broadcast notification information identifier for the broadcast notification information, and a reception ending section that ends reception of broadcast notification information containing a broadcast notification information identifier that is the same as the broadcast notification information identifier saved in the saving section.

A broadcast data transmission server of the present invention also adopts a configuration including an identifier addition section that adds a broadcast notification information identifier to broadcast notification information, a broadcast notification information transmission section that transmits the broadcast notification information, a receiving section that receives receivable notification information for the broadcast data based on the broadcast notification information, an analysis section that analyzes the receivable notification information, and a broadcast data transmission section that transmits broadcast data corresponding to the receivable notification information.

### ADVANTAGEOUS EFFECT OF THE INVENTION

According to the present invention, it is possible to reduce unnecessary power consumption accompanying the reception of broadcast data that is not desired by a user and it is possible to reduce annoyance accompanying the performing of broadcast notification by not carrying out notification for broadcast data the user does not desire.

### BRIEF DESCRIPTION OF THE DRAWINGS

FIG. 1 is a flowchart illustrating a broadcast data communication method of Embodiment 1 according to the present invention;

FIG. 2 is a configuration view of a broadcast data communication system of Embodiment 1 according to the present invention;

FIG. 3 is a block view of a broadcast data receiving terminal of a broadcast data communication system shown in FIG. 2;

FIG. 4 is a view showing broadcast notification information of the broadcast data communication method shown in FIG. 1;

FIG. 5 is a view showing broadcast program information of the broadcast data communication method shown in FIG. 1;

FIG. 6 is a view showing a display for a broadcast data receiving terminal shown in FIG. 3;

FIG. 7 is a further view showing a display for a broadcast data receiving terminal shown in FIG. 3;

FIG. 8 is a block view of a broadcast data transmission server of a broadcast data communication system shown in FIG. 2;

FIG. 9 is a sequence illustrating a broadcast data communication method of Embodiment 1 according to the present invention;

FIG. 10 is a block view of a broadcast data transmission server of a broadcast data communication system according to Embodiment 2 of the present invention;

FIG. 11 is a view showing broadcast notification information used in the broadcast data communication system according to Embodiment 2 of the present invention;

FIG. 12 is a view showing a display of a broadcast data receiving terminal of a broadcast data communication system according to Embodiment 2 of the present invention;

FIG. 13 is a further view showing a display displaying further information for the broadcast data receiving terminal shown in FIG. 12.

FIG. 14 is a sequence illustrating a data communication method according to Embodiment 2 of the present invention;

FIG. 15 is a flowchart illustrating a broadcast data communication method according to Embodiment 3 of the present invention;

FIG. 16 is a sequence illustrating a broadcast data communication method shown in FIG. 15;

FIG. 17 is a view showing broadcast notification information shown in FIG. 15;

FIG. 18 is a view showing broadcast program information contained in broadcast notification information shown in FIG. 15;

FIG. 19 is a view showing a display of a broadcast data receiving terminal of a broadcast data communication system according to Embodiment 3 of the present invention; and

FIG. 20 is a further view showing a display displaying further information for the broadcast data receiving terminal shown in FIG. 19.

### BEST MODE FOR CARRYING OUT THE INVENTION

Now, embodiments of the present invention will be described in detail with reference to the attached drawings. In the description of the embodiments, items having the same functions are given the same reference numerals and explanations thereof will be omitted.

### Embodiment 1

[Configuration of Broadcast Data Communication System]

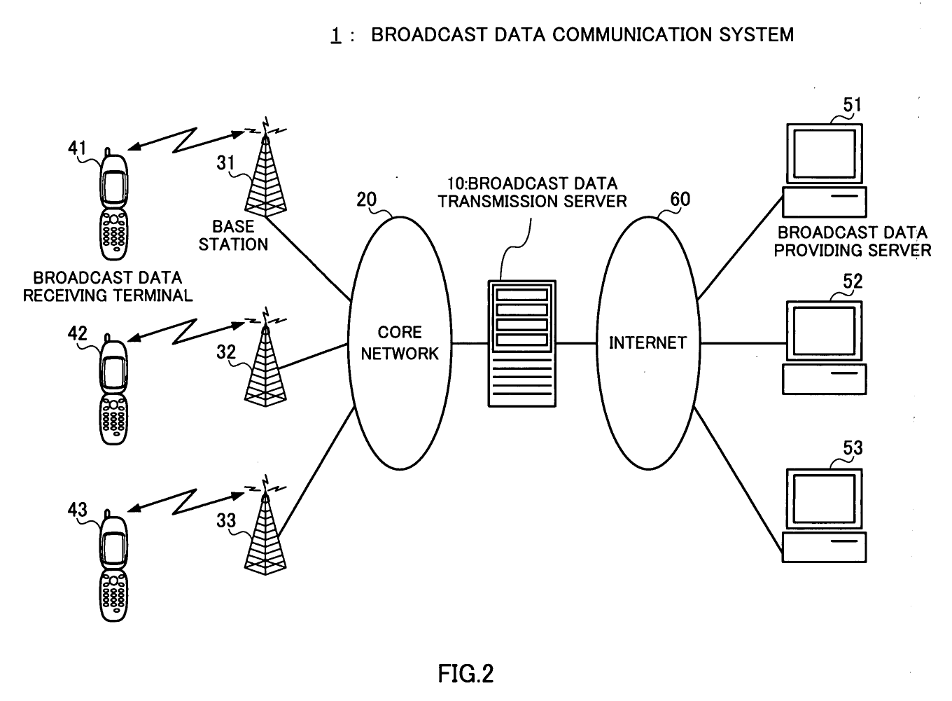

As shown in FIG. 2, a broadcast data communication system 1 according to Embodiment 1 of the present invention has a broadcast data transmission server (broadcast server) 10 for transmitting broadcast data, a plurality of broadcast data receiving terminals 41 to 43, a plurality of broadcast data providing servers 51 to 53 for providing broadcast data to the broadcast transmission server 10 via the Internet 60, and base stations 31 to 33 for receiving broadcast data from the broadcast data transmission server 10 via a core network 20, and transmitting (distributing) this broadcast data to the broadcast data receiving terminals 41 to 43. Embodiment 1 is not particularly limited with regards to the number of broadcast data receiving terminals 41 to 43, broadcast data providing terminals 51 to 53, and base stations 31 to 33.

The broadcast data transmission server 10 distributes the same broadcast data as the plurality of broadcast data receiving terminals 41 to 43. Here, the distributed broadcast data may be, for example, movies, music, news, or advertisements, etc.

[Configuration of Broadcast Data Receiving Terminal]

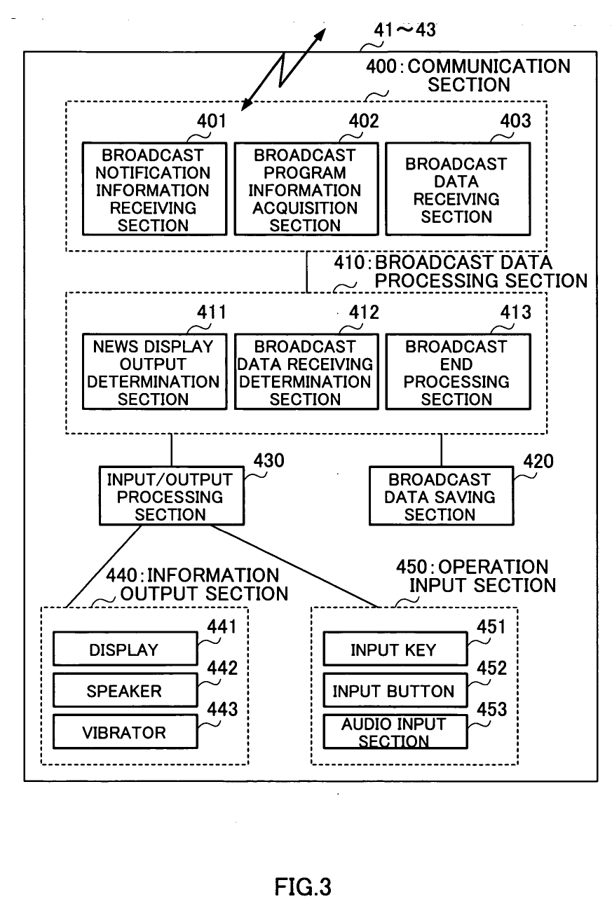

The broadcast data receiving terminals 41 to 43 are mobile telephones in Embodiment 1. As shown in FIG. 3, the broadcast data receiving terminals 41 to 43 are provided with a communication section 400 that receives broadcast notification information containing a broadcast notification information identifier, requesting and acquiring broadcast program information, and receiving broadcast data, a saving section that saves the broadcast notification information identifier of the broadcast program information, and a reception ending section that saves information indicating the end of viewing contained in the broadcast notification information identifier for end of viewing at the saving section at the time of end of viewing at and listening to the broadcast data. The broadcast data receiving terminals 41 to 43 are also further provided with a broadcast data processing section 410, input/output processing section 430, information output section 440, and operation input section 450.

The communication section is also provided with a broadcast notification information receiving section 401, a broadcast program information acquisition section 402, and a broadcast data receiving section 403.

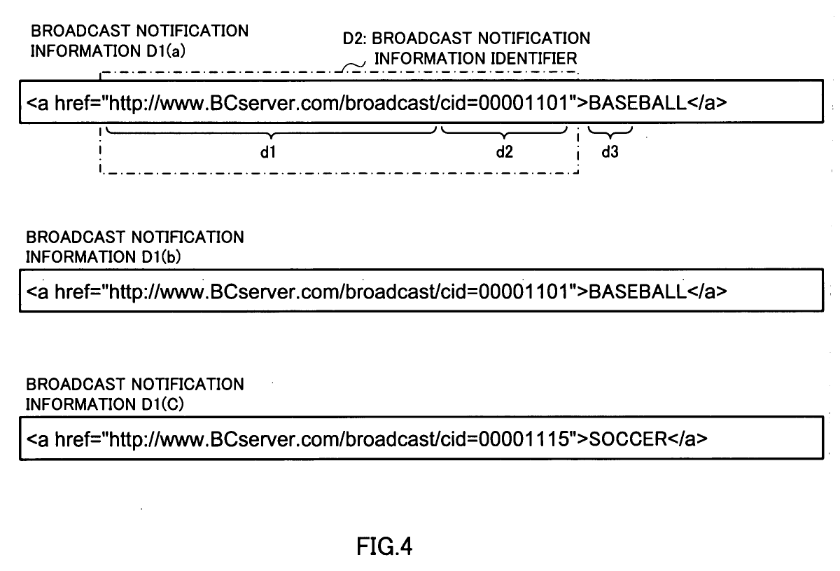

The broadcast notification information receiving section 401 receives broadcast notification information distributed from the broadcast data transmission server 10, and extracts a broadcast notification information identifier contained in this broadcast notification information. As shown in FIG. 4, in Embodiment 1, the broadcast notification information D1(a), D1(b) and D1(c) each contain position information d1 for content containing a server address, a content IDd2, and display information (character information) d3, and a broadcast notification information identifier D2 is generated using the position information d1 for the content containing the server address and the content IDd2. Broadcast notification information identifier D2 is a broadcast program information identifier for uniquely specifying broadcasted broadcast programs.

Broadcast program information acquisition section 402 acquires broadcast program information corresponding to broadcast notification information identifier D2 of broadcast notification information D1. Broadcast data receiving section 403 receives broadcast data such as images, music, news, and advertisements, etc.

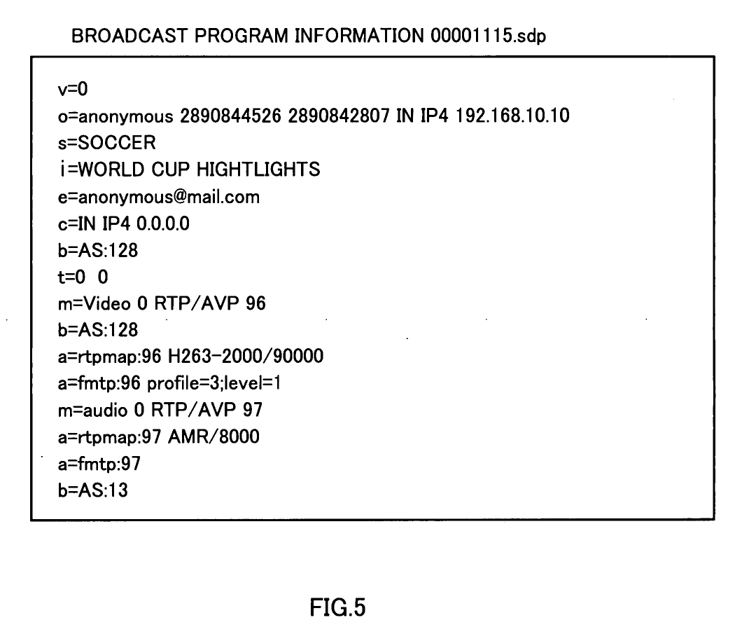

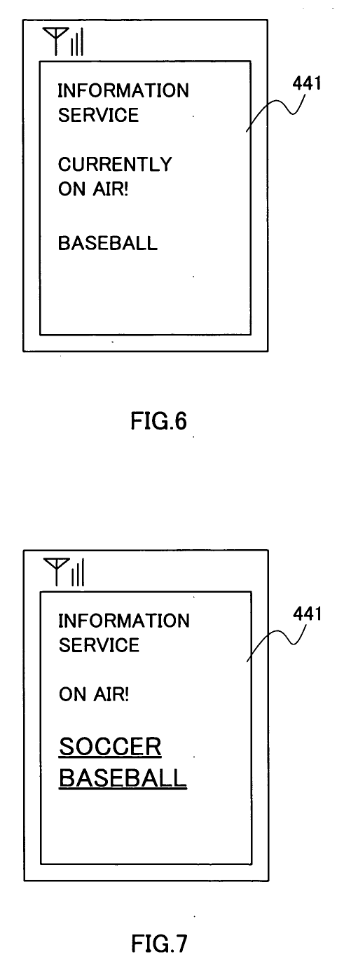

Broadcast program information acquisition section 402 sends broadcast program information corresponding to broadcast notification information identifier D2 of broadcast notification information D1 and receivable notification information (broadcast program information requests) to the effect that reception of broadcast data is possible to broadcast data transmission server 10. Here, as shown, for example, in FIG. 5, broadcast program information is information containing video content and audio content etc. displaying what kind of programs (media) are being broadcast. Specifically, the broadcast program information is information indicating broadcast programs of a “baseball” program shown in FIG. 6 and a “soccer” program and “baseball” program in FIG. 7.

The saving section is configured from broadcast data saving section 420. Broadcast data saving section 420 is capable of housing (storing) broadcast notification information identifier D2 contained in broadcast notification information D1 as “notification unnecessary information.” Any of built-in memory, specifically, erasable non-volatile memory (EEPROM, Flash Memory, etc.), read/writable volatile memory (SRAM and DRAM), or magnetic memory (Hard Disk) can be used practically at the broadcast data saving section 420. Further, external storage apparatus, for example, card memory, or stick memory etc. detachable at the broadcast data receiving terminals 41 to 43 can be used in practical terms at broadcast data saving section 420.

Broadcast data processing section 410 has a notice display output determination section 411, broadcast data receiving determination section 412, and broadcast end processing section 413. When broadcast notification information is received, notice display output determination section 411 determines the sameness of a broadcast notification information identifier D2 contained in broadcast notification information D1 with respect to broadcast notification information identifier D2 stored in broadcast data saving section 420. In the event that broadcast notification information identifier D2 is identical, notice display output determination section 411 ends reception of broadcast notification information D1 using broadcast end processing section 413, and carries out displaying to the effect that broadcast notification information D1 is received at information output section 440.

Broadcast data receiving determination section 412 then determines whether or not the broadcast data is received. Broadcast end processing section 413 then ends reception of the broadcast notification information based on the determination of notice display output determination section 411 (in the event that the broadcast notification information identifier is identical).

The input/output processing section 430 carries out control processing for executing output of image information and output of audio information at information output section 440 and carries out control processing for input information at operation input section 450.

Information output section 440 is provided with display 441, speaker 442, and vibrator 443. Display 441 is constructed from a liquid crystal (LED) or organic electroluminescence (EL) display, and displays broadcast notification information, broadcast program information, and broadcast data characters and images etc. A situation is shown where broadcast notification information indicating that “baseball” is on the air is shown at display 441 in FIG. 6. A situation is shown where broadcast notification information indicating that “soccer” and “baseball” are on the air is shown at display 441 in FIG. 7.

Speaker 442 outputs music and audio etc. for broadcast data. Vibrator 443 causes each of broadcast data receiving terminals 41 to 43 to oscillate in the event of an incoming call, the arrival of mail, the arrival of broadcast notification information, or the arrival of broadcast program information etc., so as to inform the user of these arrivals.

Operation input section 450 has an input key 451, input button 452, and audio input section 453.

[Configuration of Broadcast Data Transmission Server]

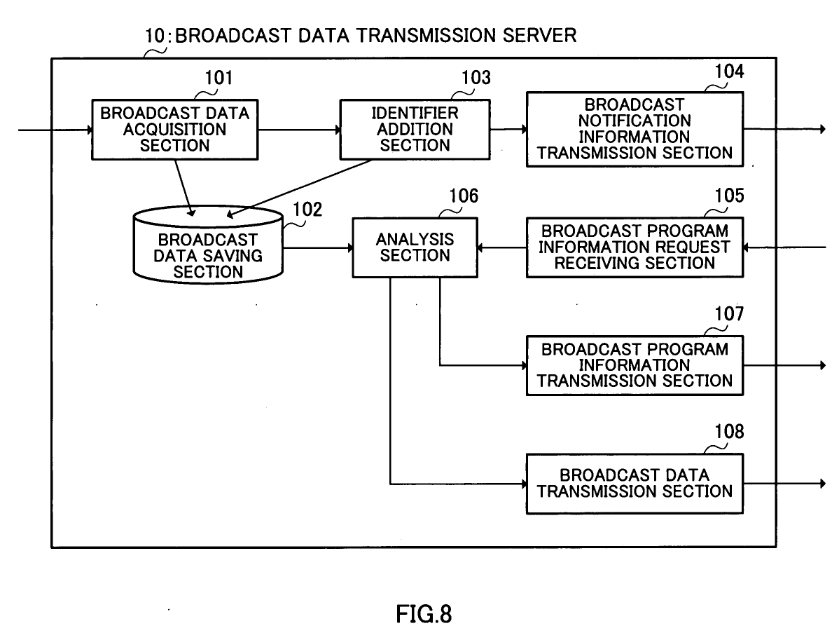

As shown in FIG. 8, broadcast data transmission server 10 has an identifier addition section that adds a broadcast notification information identifier D2 to broadcast notification information D1, a broadcast notification information transmission section that transmits broadcast notification information D1, a receiving section that receives receivable notification information (broadcast program information) for broadcast data based on broadcast notification information D1, and a broadcast data transmission section that transmits broadcast data corresponding to the receivable notification information (broadcast program information). Further, broadcast data transmission server 10 has a broadcast data acquisition section 101, broadcast data saving section 102, and broadcast program information transmission section 107.

As shown in FIG. 2, broadcast data acquisition section 101 acquires transmission data from broadcast data providing servers 51 to 53 via the Internet 60. The acquired broadcast data is then saved in broadcast data saving section 102.

The identifier addition section is composed of identifier addition section 103. Identifier addition section 103 adds broadcast notification information identifier D2 to broadcast notification information D1 transmitted from broadcast data acquisition section 101. Broadcast notification information transmission section 104 sends (distributes) the broadcast notification information D1 with broadcast notification information identifier D2 added to broadcast data receiving terminals 41 to 43. Further, broadcast data saving section 102 correlates the broadcast notification information D1 with broadcast notification information identifier D2 added with the broadcast data and saves this.

The receiving section is constructed from broadcast program information request receiving section (receivable notification information receiving section) 105. Receivable notification information receiving section 105 receives broadcast program information requests (receivable notification information) transmitted from broadcast data receiving terminals 41 to 43.

An analyzing section is constructed from analysis section 106. Analysis section 106 analyzes receivable notification information received at receivable notification information receiving section 105. Broadcast program information transmission section 107 transmits broadcast program information.

Broadcast data transmission section is constructed from broadcast data transmission section 108. Broadcast data transmission section 108 transmits (distributes) broadcast data to broadcast data receiving terminals 41 to 43 based on receivable notification information sent from broadcast data receiving terminals 41 to 43.

[Broadcast Data Communication Method]

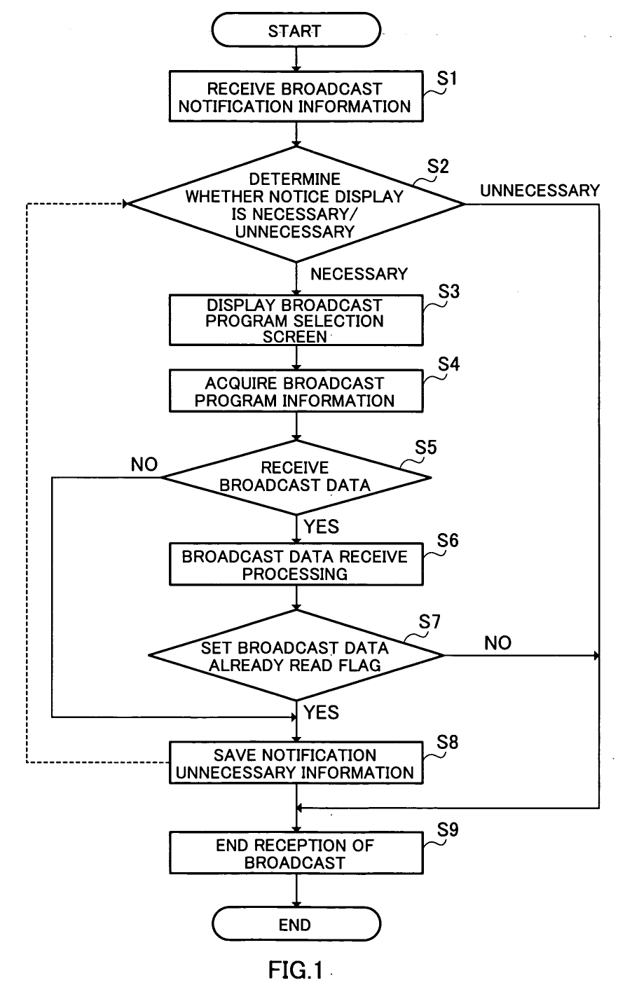

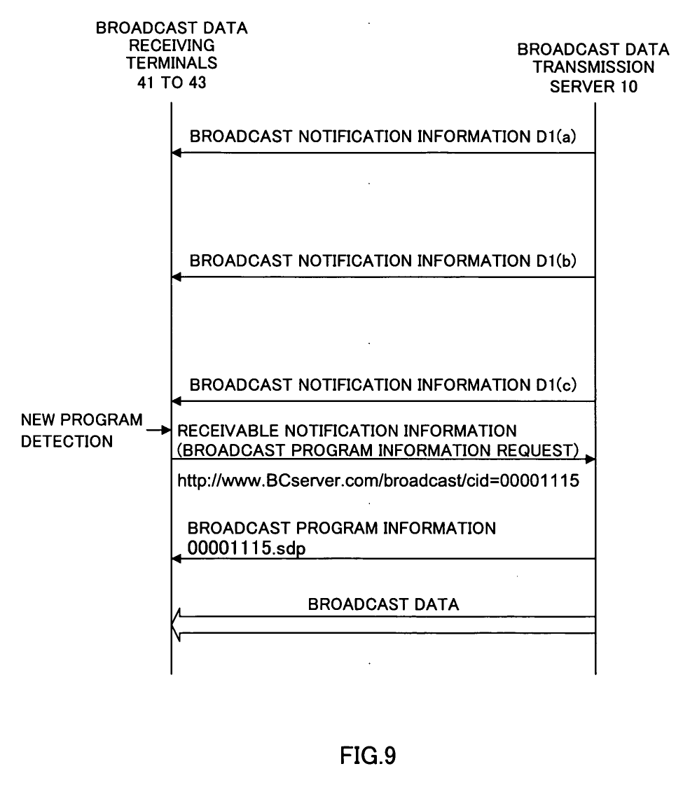

Next, a description is given using FIG. 1 and FIG. 9 of a broadcast data communication method at broadcast data transmission system 1 shown in FIG. 2.

First, broadcast data containing content such as images, music, news, and advertisements etc. is received via the Internet 60 from broadcast data providing servers 51 to 53 shown in FIG. 2 at broadcast data acquisition section 101 of broadcast data transmission server 10 shown in FIG. 8. Broadcast data acquisition section 101 then saves the received broadcast data in broadcast data saving section 102. At identifier addition section 103, broadcast notification information D1 is sent from broadcast data acquisition section 101, and broadcast notification information identifier D2 shown in FIG. 4 is added to this broadcast notification information D1. Broadcast notification information D1 with broadcast notification information identifier D2 added is then sent from broadcast notification information transmission section 104 to broadcast data receiving terminals 41 to 43.

As shown in FIG. 2, broadcast notification information D1 sent from broadcast data transmission server 10 is distributed to broadcast data receiving terminals 41 to 43 via core network 20 and base stations 31 to 33. As shown in FIG. 4 and FIG. 9, by distributing broadcast notification information D1 from broadcast data transmission server 10 to broadcast data receiving terminals 41 to 43, broadcast notification information identifier D2 contained in broadcast notification information D1 can also be sent from broadcast data transmission server 10 to broadcast data receiving terminals 41 to 43.

At broadcast data receiving terminals 41 to 43, as shown in step S1 of FIG. 1, broadcast notification information D1 is received at broadcast notification information receiving section 401 of communication section 400 shown in FIG. 3. As shown in step S2, broadcast notification information identifier (notification unnecessary information) D2 stored in broadcast data saving section 420 is referred to, and a determination is made at notice display output determination section 411 of broadcast data processing section 410 as to whether or not broadcast notification information identifier D2 of broadcast notification information D1 is a broadcast notification information identifier D2 that is already stored in broadcast data saving section 420.

In the event that it is determined that the received broadcast notification information identifier D2 of broadcast notification information D1 is the same as the already stored broadcast notification information identifier D2, this means that the user has already viewed to the broadcast notification information D1. Input/output processing section 430 then carries out control for not displaying giving an indication to the effect that broadcast notification information D1 has been received at display 441 of information output section 440 based on determination results of notice display output determination section 411. Broadcast data receiving determination section 412 then determines whether or not the reception of broadcast program information and broadcast data corresponding to the broadcast program identifier contained in the broadcast notification information D1 has been carried out, and as shown in step S9, at broadcast end processing section 413, ends reception of the broadcast program information and broadcast data thereafter (stops reception). Namely, at broadcast data receiving terminals 41 to 43, receivable notification information requiring broadcast program information and broadcast information for the broadcast data transmission server 10 is not sent and broadcast program information and broadcast data are not displayed at information output section 440. As a result, it is possible to ensure that broadcast program information and broadcast data not desired by the user is automatically not received in an effective manner at broadcast data receiving terminals 41 to 43 based on broadcast notification information identifier D2 of broadcast notification information D1.

Specifically, in the event that broadcast notification information D1(a) shown in FIG. 4 and FIG. 9 is received first, broadcast notification is carried out as shown in FIG. 6 because broadcast notification unnecessary information is not saved at broadcast data saving section 420. If a user is then interested in a broadcast relating to a “baseball” program as shown in FIG. 6, the “baseball” program is selected. If broadcast notification unnecessary information is saved in the broadcast data saving section 420, the user is not notified (S2). Here, if the user has already seen the broadcast data relating to the “baseball” program, the user is not notified even if a second broadcast notification information D1(b) is received. That broadcast notification information D1(a) and D1(b) are the same broadcast data is determined with broadcast notification information identifier D2. Next, in the event that a third broadcast notification information D1(c) is received, broadcast notification information identifier D2(c) of broadcast notification information D1(c) is not saved at broadcast data saving section 420 (S2), and the user is therefore notified (S3). At this time, an example of notification to the user is shown as in FIG. 7. Here, a new broadcast of a “soccer” program, and an already viewed “baseball” program are displayed as broadcast data that can currently be received. The newly broadcast program and the already viewed broadcast program can be easily distinguished between by changing, for example, the size of the characters, or the color, etc. It is possible to determine whether or not the already viewed broadcast data is effective at the current time by including broadcast period information in the broadcast program information.

Here, when a “soccer” program is selected by the user, broadcast program information is acquired by broadcast program information acquisition section 402 (S4). Broadcast program information identifier (http://www.BCserver.com/broadcast/cid=00001115) is contained in the broadcast program information request (receivable notification information), and it can be understood which broadcast program information is requested at the broadcast data transmission server 10.

Next, when broadcast program information is received, detailed information for a program included in the broadcast program information is displayed. Here, “World Cup Highlights” is displayed. The user then selects whether or not to view the broadcast data (S5) If viewed, the broadcast data is received (S6). If not viewed, the broadcast notification information not being necessary is saved in broadcast data saving section 420 (S8).

Further, in the event that broadcast notification information D1(c) is received at broadcast data receiving terminals 41 to 43, it is determined that content IDd2 of broadcast notification information identifier D2 stored in broadcast data saving section 420 and content IDd2 of broadcast notification information identifier D2 of the received broadcast notification information D1(c) are not the same, and a display to the effect that broadcast notification information D1(c), i.e. “soccer” program, is displayed in addition to “baseball” program as shown in FIG. 7.

On the other hand, in step S2, in the event that broadcast notification information identifier D2 of the received broadcast notification information D1 is not the same as broadcast notification information identifier D2 already stored, this means that the broadcast notification information D1, broadcast program information and broadcast data have not been viewed by the user (“new program detection” in FIG. 9). Input/output processing section 430 then displays an image indicating that broadcast notification information D1 has been received at display 441 of information output section 440 based on determination results of notice display output determination section 411. Further, audio or music to the effect that broadcast notification information D1 is received is outputted at speaker 442, or an oscillation indicating reception of broadcast notification information D1 is issued at vibrator 443.

When broadcast notification information D1 is received, broadcast program information acquisition section (receivable notification information transmission section) 402 of broadcast data receiving terminals 41 to 43 sends receivable notification information (broadcast program information request) informing that reception of broadcast program information and broadcast data is possible at broadcast data transmission server 10. This receivable notification information is then received at receivable notification information receiving section 105 of broadcast data transmission server 10 shown in FIG. 8. Receivable notification information receiving section 105 then analyzes the content of the receivable notification information at analysis section 106, and extracts broadcast program information and broadcast data corresponding to the receivable notification information stored in broadcast data saving section 102.

Broadcast program information stored in broadcast data saving section 102 is then sent to broadcast data receiving terminals 41 to 43 to which the receivable notification information is transmitted at broadcast program information transmission section 107. Broadcast data receiving terminals 41 to 43 then receive this information at broadcast program information acquisition section 402 of communication section 400 shown in FIG. 3. As shown in step S3, broadcast program information is displayed at display 441 of information output section 440 shown in FIG. 6 and FIG. 7 as a broadcast program selection screen.

As shown in step S4, the user can acquire broadcast programs as desired based on broadcast program information displayed at display 441 as a broadcast program selection screen. Next, as shown in step S5, whether or not to receive broadcast data for acquired broadcast programs is determined by the user himself or herself. This operation is carried out at operation input section 450 for broadcast data receiving terminals 41 to 43 shown in FIG. 3.

In the event that it is determined to receive the broadcast data, the broadcast data shown in FIG. 9 from broadcast data transmission section 108 of broadcast data transmission server 10 shown in FIG. 8 is received at broadcast data receiving section 403 of communication section 400 for broadcast data receiving terminals 41 to 43 shown in FIG. 3. The received broadcast data is determined to indicate reception at broadcast data receiving determination section 412 of broadcast data processing section 410, and as shown in step S6, reception processing of broadcast data is executed at input/output processing section 430 and is played back at information output section 440.

In the event that broadcast data is received at broadcast data receiving terminals 41 to 43, as shown in step S7, a broadcast data already read flag indicating that data has already been read is set at broadcast data receiving determination section 412. Setting of the broadcast data already read flag can be carried out by the user himself or herself, or can be carried out automatically by a program or logic circuit.

When the broadcast data already read flag is set, this broadcast data already read flag is sent from broadcast data receiving terminals 41 to 43 to broadcast data transmission server 10 as notification unnecessary information without giving notification of receivable notification information, and is stored in broadcast data saving section 420 shown in FIG. 3. After notification unnecessary information is stored in broadcast data saving section 420, as shown in step S9, reception of broadcast data ends. If it is the user subsequently wishes that the reception of broadcast notification information D1 is not necessary at broadcast data receiving terminals 41 to 43, the broadcast program identifier is made to correspond to this indication, and may be stored in broadcast data saving section 420.

On the other hand, in the event that a broadcast data already read flag is not set, as shown in the same step S9, reception of the broadcast data ends. Further, in step S5 described above, in the event that broadcast data is not received, as in the case where the broadcast data already read flag is set, as shown in step S8, the notification unnecessary information is made to correspond to broadcast notification information identifier D2 and is stored in broadcast data saving section 420. Then, as shown in step S9, reception of the broadcast data ends.

Even if notification unnecessary information is stored in broadcast data saving section 420 of broadcast data receiving terminals 41 to 43, it is possible for the user to refer to the broadcast program information and received broadcast data, and the action of receiving the broadcast data desired by the user is not prevented.

Further, in Embodiment 1, a description is given of an example where reception of broadcast program information and broadcast data is controlled using broadcast notification information identifier D2 of already read broadcast notification information D1, but it is also possible for the present invention to control reception of broadcast program information and broadcast data using broadcast program information identifiers for the broadcast program information.

According to Embodiment 1, it is possible to end reception of broadcast notification information D1 containing the same broadcast notification information identifier D2 based on the broadcast notification information identifier D2 contained in the broadcast notification information D1. It is therefore possible to stop the reception of broadcast data that is not desired by the user. In particular, in the event that the same broadcast notification information is repeatedly distributed periodically, at broadcast data receiving terminals 41 to 43, it is possible to reduce the annoyance of users to control of reception of broadcast program information and broadcast data frequently.

### Embodiment 2

In Embodiment 2 of the present invention, a description is given of the case of carrying out reception control of broadcast data taking a service identifier indicating a broadcast group set constructed from one or more items of broadcast program information as a broadcast notification information identifier for a broadcast data communication method, broadcast data receiving terminals 41 to 43, and broadcast data communication system 1.

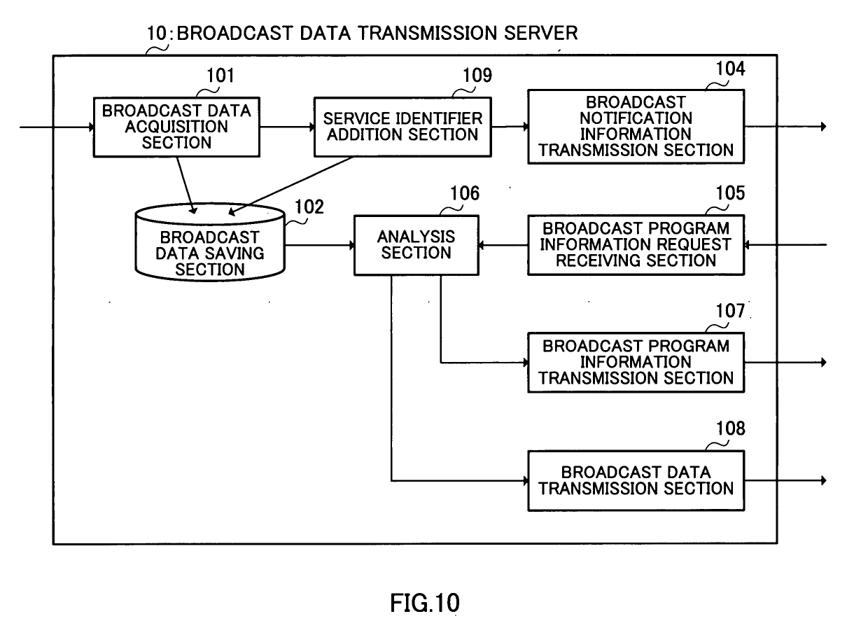

The basic configuration of broadcast data transmission server 10 of broadcast data communication system 1 according to Embodiment 2 is the same as the broadcast data transmission server 10 shown in FIG. 8 according to Embodiment 1 with the exception that a service identifier addition section 109 is provided in place of identifier addition section 103 as shown in FIG. 10.

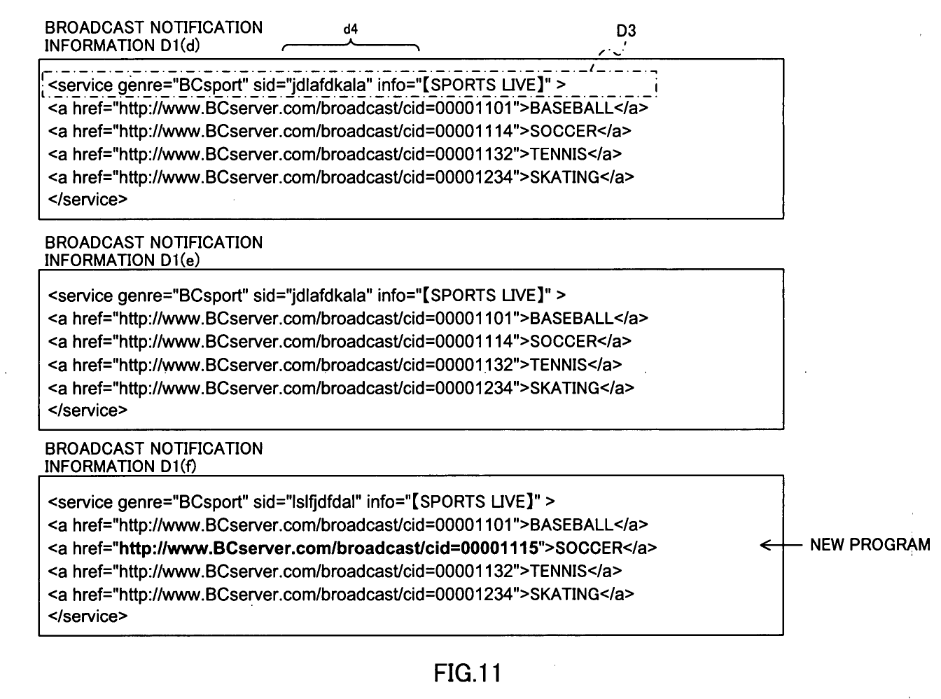

As shown in FIG. 11, the broadcast notification information D1 (d to f) contains broadcast service information D3 indicating a group of broadcast programs constructed from one or more items of broadcast program information such as “baseball” program, and “soccer” program, etc., and this broadcast service information D3 is used as a broadcast notification information identifier. More specifically, it is possible to identify between broadcast notification information D1(d), D1(e) and D1(f) respectively based on service identifier d4. Service identifier d4 is a hash value (“jdlafdkala”) for information for a broadcast program group.

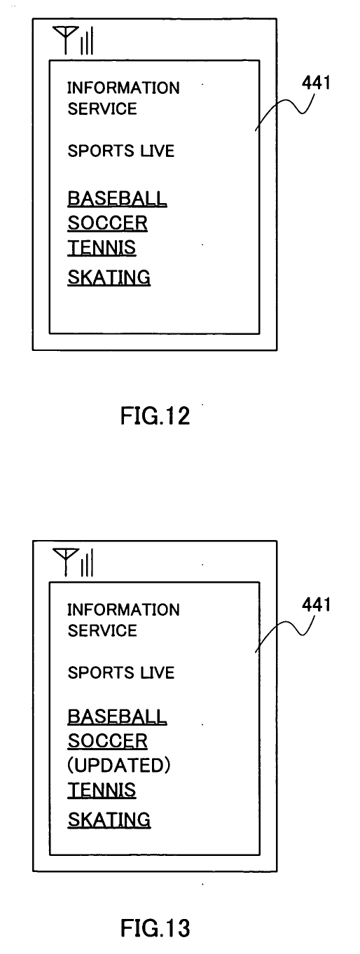

Broadcast notification information D1(d) or D1(e) is displayed as shown, for example, in FIG. 12 at the display 441 of broadcast data receiving terminals 41 to 43. Broadcast notification information D1(f) is distinct from broadcast notification information D1(d) or service identifier D3 for D1(e), and is displayed, for example, as shown in FIG. 13, at display 441.

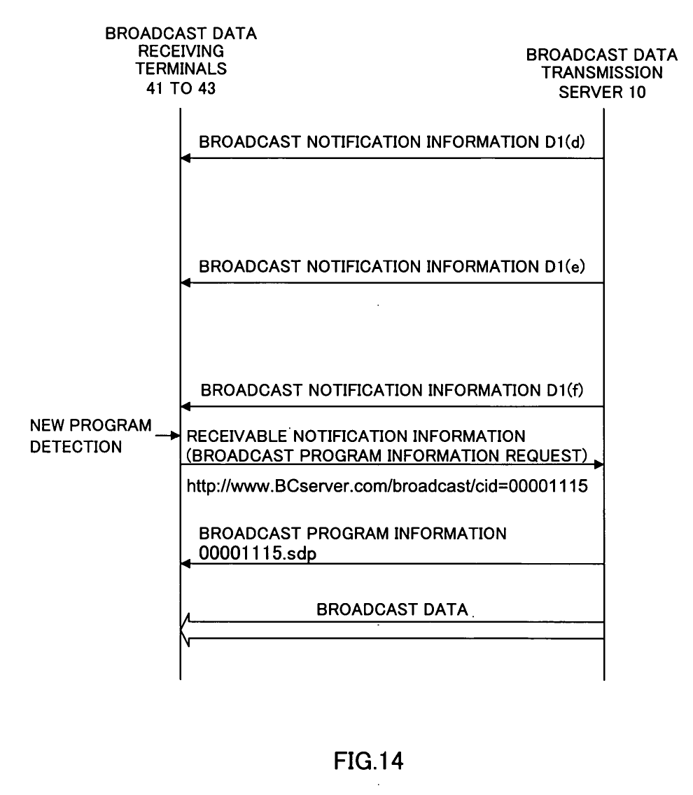

At broadcast data communication system 1, the flow of the broadcast notification information D1(d), D1(e), D1(f), the receivable notification information, broadcast program information and broadcast data information is basically the same as the flow of information of the broadcast data communication system 1 shown in FIG. 9, and is as shown in FIG. 14. Further, the broadcast data communication method is basically the same as the steps shown in FIG. 1 according to Embodiment 1 and explanations thereof will be omitted.

According to Embodiment 2, in addition to the results obtained by the broadcast data communication method, broadcast data receiving terminals 41 to 43, and broadcast data communication system 1 according to Embodiment 1, one or more items of broadcast program information are taken as a single broadcast program group and a service identifier d4 for identifying this broadcast group is used as a broadcast notification information identifier for broadcast notification information. Broadcast notification information is therefore no longer received every one broadcast program, the distribution frequency for the broadcast notification information can be reduced, together with reception frequency.

### Embodiment 3

In Embodiment 3, a description is given of the case of reducing the data size of broadcast notification information D1 in the broadcast data communication method, broadcast data receiving terminals 41 to 43 and broadcast data communication system 1.

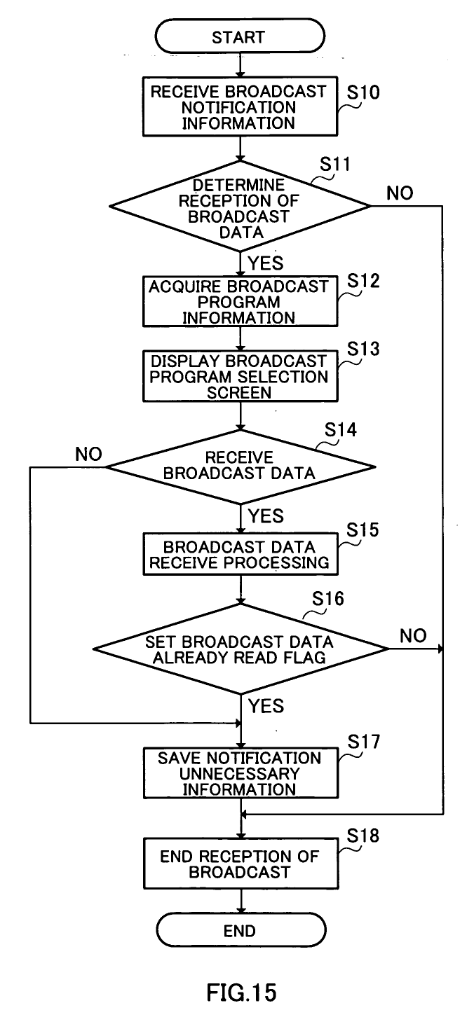

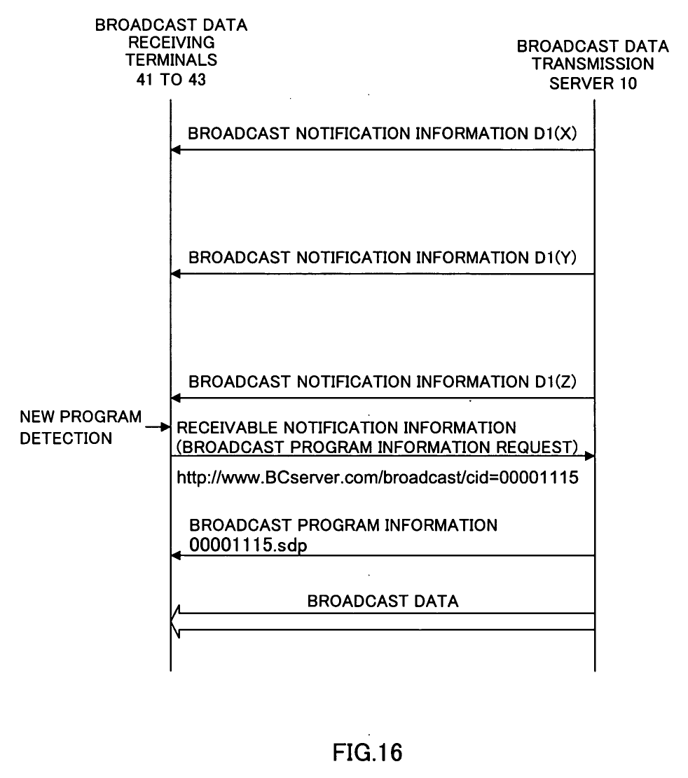

As shown in FIG. 15 and FIG. 16, in the broadcast data communication method according to Embodiment 3, in step S10, broadcast notification information D1 is received at broadcast data receiving terminals 41 to 43. Then, as shown in step S11, it is determined whether or not to receive broadcast data based on this broadcast notification information D1.

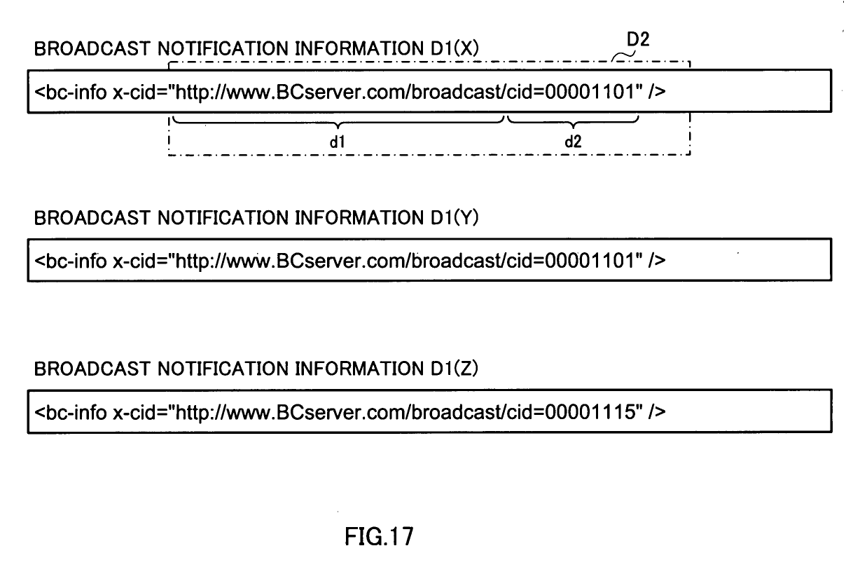

Regarding the broadcast notification information D1 shown in FIG. 1 according to Embodiment 1 described above, the broadcast notification information D1(X), D1(Y) and D1(Z) shown in FIG. 17 is information configured from only position information d1 of content containing a server address, and broadcast notification information identifier D2 containing the content IDd2, without display information d3.

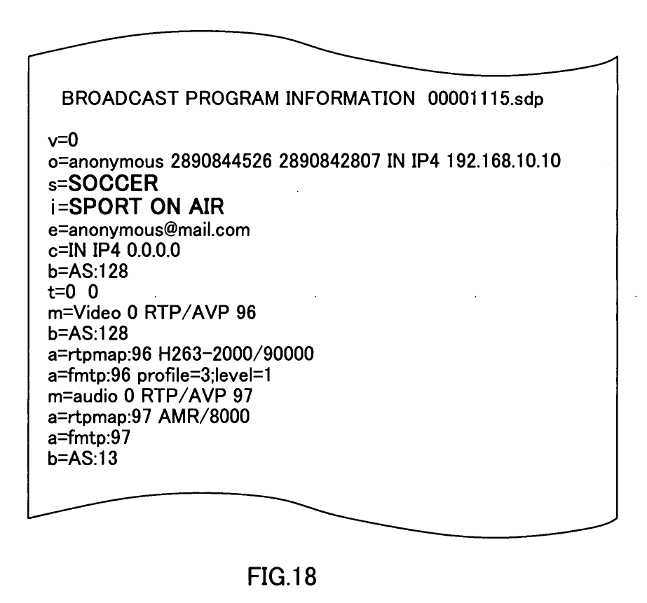

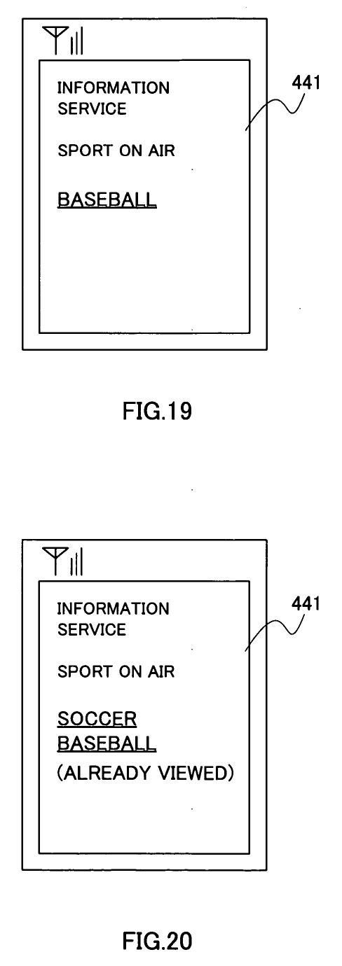

In step S1, in the event that it is determined that broadcast data is not received, reception of the broadcast data ends, as shown in step S18. In the event that it is determined that broadcast data is received, broadcast program information is acquired as shown in step S12. Broadcast program information is, for example, provided with information shown in FIG. 18. As shown in step S13, the broadcast program selection screen is then displayed at display 441 of broadcast data receiving terminals 41 to 43 based on this broadcast program information. At display 441 shown in FIG. 19, broadcast program information based on broadcast notification information D1(X) and D1(Y) shown in FIG. 17 is displayed. Broadcast program information is then displayed based on broadcast notification information D1(Z) at display 441 shown in FIG. 20.

As shown in step S14, the user selects whether or not to receive broadcast data. In the event that broadcast data is received, as shown in step S15, as with the broadcast data communication method according to Embodiment 1, receivable notification information is sent from broadcast data receiving terminals 41 to 43 to broadcast data transmission server 10. It is then possible to receive broadcast data at broadcast data receiving terminals 41 to 43 in accompaniment with transmission of receivable notification information. The received broadcast data is then subjected to reception processing. In FIG. 14, receivable notification information is taken to be broadcast program request information, but the broadcast possible notification information may also be transmitted and received separately.

In step S16, it is determined whether or not a broadcast data already read flag is set. In the event that a broadcast data already read flag is set, broadcast notification information identifier D2 is stored in broadcast data saving section 420 as shown in FIG. 3 as communication unnecessary information. In the event that a broadcast data already read flag is not set, as shown in step S18, reception of the broadcast data ends.

On the other hand, in step S14, in the event that broadcast data is not received, as shown in step S17, notification unnecessary information is stored in broadcast data saving section 420.

According to Embodiment 3, receivable notification information is transmitted after a stage of requesting broadcast program information and a stage of acquiring broadcast program information. It is therefore no longer necessary to include broadcast program information in broadcast notification information D1 and the data size of broadcast notification information D1 can be smaller. The broadcast notification information may also be such that D1 uses a broadcast service identifier.

This present application is based on Japanese Patent Application No. 2004-29888, filed on Feb. 5, 2004, the entire content of which is expressly incorporated by reference herein.

### INDUSTRIAL APPLICABILITY

The broadcast data communication method, broadcast data receiving terminal and broadcast data communication system according to the present invention are capable of reducing unnecessary power consumption accompanying the reception of broadcast data the user does not desire, and is effective in reducing the frustration accompanying being notified of broadcasts by not carrying out broadcast notification relating to broadcast data the user does not desire, and are particularly effective as a broadcast data communication method, broadcast data receiving terminal and broadcast data communication system for a pocket pager, wireless equipment, mobile information terminal (PDA: Personal Digital Assistant), notebook-type personal computer, or personal computers etc. on a network constructed from wireless or wired LAN's.

1. A broadcast data communication method comprising:
a transmission step of transmitting broadcast notification information containing a broadcast notification information identifier by a server;
a receiving step of receiving of the broadcast notification information by a terminal;
a transmission step of transmitting receivable notification information for the broadcast data from the terminal to the server based on the broadcast communication information;
a transmission step of transmitting broadcast data based on the receivable notification information by the server;
a receiving step of receiving the broadcast data by the terminal; and
an ending step of saving the broadcast notification information identifier of the broadcast notification information, and ending reception of broadcast notification information containing a broadcast notification information identifier that is the same as the saved broadcast notification information identifier by the terminal.

2. The broadcast data communication method according to claim 1, wherein the broadcast notification information identifier is a broadcast notification information identifier uniquely specifying broadcast program information.

3. The broadcast data communication method according to claim 1, wherein the broadcast notification information identifier is a broadcast notification information identifier uniquely specifying broadcast program information that receives and plays back the broadcast data.

4. The broadcast data communication method according to claim 1, wherein the broadcast notification information identifier is a service identifier for uniquely specifying a broadcast program group comprised of one or more items of broadcast program information.

5. A broadcast data receiving terminal comprising:
a communication section that receives broadcast communication information containing a broadcast notification information identifier and broadcast data, and transmits receivable notification information for the broadcast data;
a saving section that saves a broadcast notification information identifier for the broadcast notification information; and
a reception ending section that ends reception of broadcast notification information containing a broadcast notification information identifier that is the same as the broadcast notification information identifier saved in the saving section.

6. The broadcast data receiving terminal according to claim 5, wherein the reception ending section ends reception of the broadcast notification information and does not send receivable information for the broadcast data.

7. A data transmission server comprising:
an identifier addition section that adds a broadcast notification information identifier to broadcast notification information;
a broadcast notification information transmission section that transmits the broadcast notification information;
a receiving section that receives receivable notification information for the broadcast data based on the broadcast notification information;
an analysis section that analyzes the receivable notification information; and
a broadcast data transmission section that transmits broadcast data corresponding to the receivable notification information.
